(19) United States
(12) Patent Application Publication
(10) Pub. No.: US 2018/0143886 A1
(43) Pub. Date: May 24, 2018

(54) Method for Rebuilding a Mapping Table of a Solid State Disk

(71) Applicant: QUANTA STORAGE INC., Taoyuan City (TW)

(72) Inventors: An-Te Liu, Taoyuan City (TW); Jin-Shing Hsieh, Taoyuan City (TW)

(21) Appl. No.: 15/638,389

(22) Filed: Jun. 30, 2017

(30) Foreign Application Priority Data
Nov. 23, 2016 (CN) 201611037058.9

(51) Int. Cl. G06F 11/14; G06F 12/02

(52) U.S. Cl. CPC G06F 11/1471; G06F 12/0246; G06F 11/1469

(57) ABSTRACT

A method for rebuilding a mapping table of a solid state disk includes maintaining the mapping table saved on the buffer memory dynamically, backing up the mapping table regularly, processing user data and a backup mapping table simultaneously for writing to a flash memory array, recording differences between the mapping table and the backup mapping table simultaneously during a backup period, backing up the differences to the flash memory array continuously after the backup mapping table is written to the flash memory array, reading the backup mapping table and backup differences after power is turned on, and rebuilding the backup mapping table according to the backup differences in the buffer memory.

### BACKGROUND OF THE INVENTION

### 1. Field of the Invention

The present invention illustrates a method for rebuilding a mapping table, and more particularly, the method for rebuilding a logical to physical mapping table of a solid state disk.

### 2. Description of the Prior Art

A solid state disk (SSD) can be regarded as a single memory device including several NAND flash memory arrays. Since the number of erasures of a flash memory is limited, data has to be saved in different spaces with dispersive addresses in the NAND flash memory arrays of the SSD. Further, the SSD can use a logical to physical mapping table (hereafter, say “mapping table”) for managing a correlation between logical addresses of the data and physical addresses (i.e., actual addresses of the data saved in a flash memory array) of the data. By using the logical to physical mapping table, data of the SSD can be rapidly searched and accessed.

In FIG. 8, when a conventional SSD is powered up, management data of each data segment of a flash memory array 1 can be read out in order to manage a correlation between logical addresses of the data and physical addresses (i.e., actual addresses of the data saved in the flash memory array 1) of the data. Then, a mapping table including the logical addresses and the physical addresses can be generated according to the management data and then saved in a buffer memory 2. Since the buffer memory 2 belongs to a volatile random access memory, when the power is turned off, all data of the buffer memory 2 may be immediately disappeared. It implies that the mapping table in the buffer memory 2 may be disappeared when the power is turned off. Thus, the mapping table has to be backed up in the flash memory array 1 (i.e., the flash memory array 1 belongs to a non-volatile memory array). By doing so, when the power is turned on again, the “backup mapping table” saved in the flash memory array 1 can be read out for rebuilding the mapping table in the buffer memory 2.

In a conventional method for rebuilding the mapping table of the SSD, the SSD usually uses an idle time slot of accessing user data 3 during a time interval for backing up the mapping table to the flash memory array 1 in avoidance of decreasing operation efficiency for accessing user data 3 of the buffer memory 2. When the mapping table starts to back up, the user data 3 is accessed according to a command. If data of the mapping table to be backed up (say, data of the backup mapping table 4) is not much, the SSD can respond to the command generated from a host immediately. Thus, the operation efficiency for accessing the user data 3 can be maintained. However, if data of the backup mapping table 4 is overmuch, it requires a lot of time for writing the backup mapping table 4 to the flash memory array 1. Thus, the SSD may not respond to the command generated from the host. The operation efficiency for accessing the user data 3 may be severely decreased. In an extreme case, the operation efficiency is decreased to zero. In this case, a user may spend a lot of time waiting for the response of the SSD.

In another conventional method for rebuilding the mapping table of the SSD, the backup mapping table 4 and the user data 3 are written to the flash memory array 1 at the same time. Although operation efficiencies for accessing the user data 3 and the backup mapping table 4 are decreased, the operation efficiency for accessing the user data 3 is slightly decreased. In other words, the operation efficiency for accessing the user data 3 can be maintained to a tolerable performance. The extreme case of zero operation efficiency can be avoided here. In other words, spending a lot of time waiting for the response of the SSD by the user can also be avoided.

However, when the backup mapping table 4 is written to the flash memory array 1, user data 5 in front of the user data 3 may also be introduced to the flash memory array 1. The user data 5 may cause some amendments of the backup mapping table 4 saved in the flash memory array 1. When the power is turned off, the user data 3 can be written to the flash memory array 1. Unfortunately, the backup mapping table 4 writing from the buffer memory 2 to the flash memory array 1 cannot be updated according to differences (or say, amendments caused by introducing user data 5). Therefore, when the power is turned on again, the conventional SSD has to read out the backup mapping table 4 in the flash memory array 1. Then, the conventional SSD requires a lot of time to scan all data segments of the memory. Further, the conventional SSD has to search differences for updating and rebuilding the mapping table, leading to decreased operation efficiency or booting efficiency of the SSD. Thus, to develop an efficient method for rebuilding the mapping table of the SSD is still an open question.

### SUMMARY OF THE INVENTION

The present invention aims at providing a method for rebuilding the mapping table of the solid state disk. When the backup mapping table is written to the flash memory array, differences of the backup mapping table are recorded over time. The backup mapping table and backup differences are saved in the flash memory array. When the power is turned on again, the backup mapping table and the backup differences can be read out. Thus, since the mapping table can be rapidly rebuilt by updating the backup mapping table according to the backup differences, operation efficiency for accessing data can be improved.

The present invention aims at providing a method for rebuilding the mapping table of the solid state disk. When a backup period elapses, record a data page as a flag data page having user data at the same time, record a blank data segment value prepared to be used, and read a recorded flag data page and a data page with recorded data following the recorded flag data page. Further, after the backup period elapses, rebuild entries of a mapping table corresponding to a data page used to save user data according to a sequence of time labels of data pages with recorded data. By doing so, a processing time for rebuilding the mapping table can be reduced.

To achieve aforementioned purposes, a method for rebuilding the mapping table of the solid state disk includes maintaining the mapping table saved on the buffer memory dynamically, backing up the mapping table regularly, processing user data and the backup mapping table simultaneously for writing to the flash memory array, recording differences between the mapping table and the backup mapping table simultaneously during the backup period, backing up the differences to the flash memory array continuously after the backup mapping table is written to the flash memory array, reading the backup mapping table and backup differences after power is turned on, and rebuilding the backup mapping table according to the backup differences in the buffer memory.

Another method for rebuilding the mapping table of the solid state disk includes when the backup period elapses, writing the backup differences to the flash memory array, recording a data page as a flag data page having user data at the same time, and recording a blank data segment value prepared to be used. After the mapping table is generated, read a recorded flag data page, read a data page with recorded data following the recorded flag data page according to a default programming sequence, and read a data page with recorded data from the blank data segment prepared to be used. If time labels of data pages are not increased from a time label of the flag data page, complete a process for rebuilding the mapping table by using a mapping table currently presented. If time labels of the data pages are increased from a time label of the flag data page, update the mapping table currently presented according to the data pages already read, and then complete the process for rebuilding the mapping table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an electronic storage system according to an embodiment of the present invention.

FIG. 2 is an illustration of a method for backing up a mapping table of a solid state disk in FIG. 1.

FIG. 3 is a flow chart of a method for rebuilding the mapping table of the solid state disk in FIG. 1.

FIG. 4 is an illustration of another method for backing up the mapping table of the solid state disk in FIG. 1.

FIG. 5 is a structure of a flash memory array of the solid state disk in FIG. 1.

FIG. 6 is a structure of a data page of the solid state disk in FIG. 1.

FIG. 7 is a flow chart of another method for rebuilding the mapping table of the solid state disk in FIG. 1.

FIG. 8 is an illustration of a method for backing up a mapping table of a solid state disk in prior art.

### DETAILED DESCRIPTION

For the present invention to achieve above purposes, the use of technology and its effects hereby cite the preferred embodiment, and with the drawings to be described below.

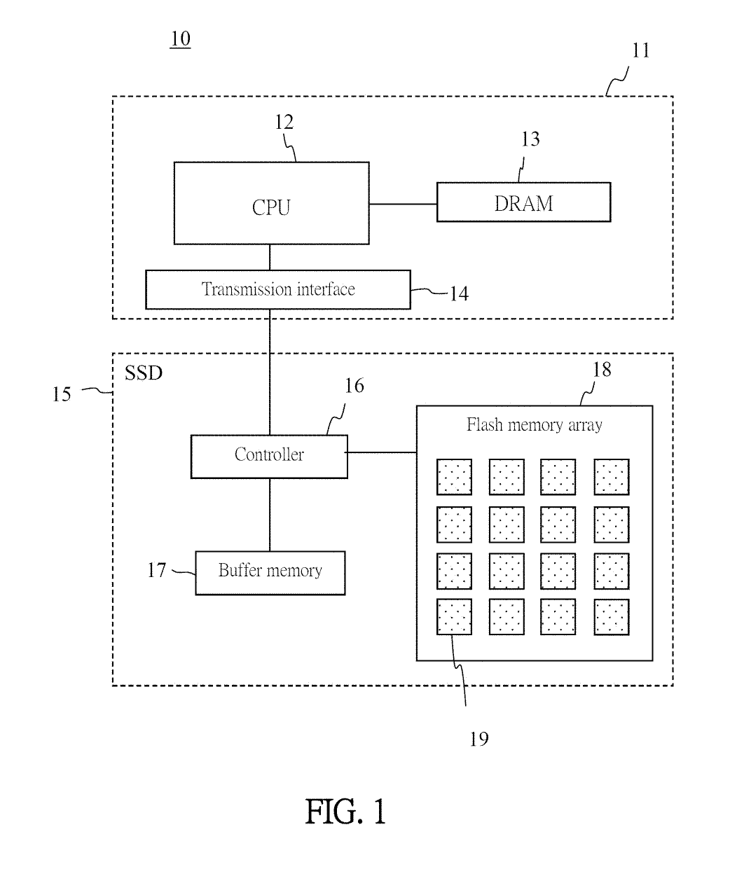

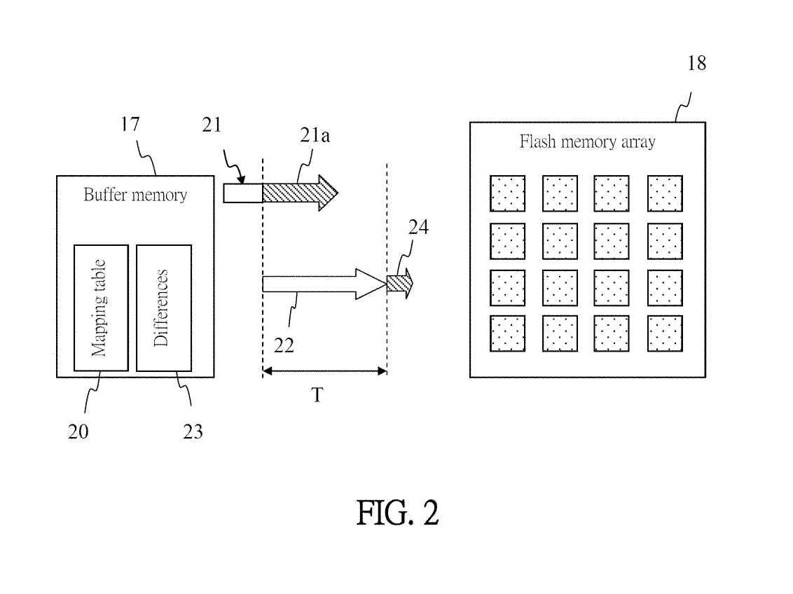

Please refer to FIG. 1 and FIG. 2. FIG. 1 is a block diagram of an electronic storage system 10 according to an embodiment of the present invention. FIG. 2 is an illustration of a method for backing up a mapping table 20 of a solid state disk 15. In FIG. 1, the electronic storage system 10 includes a host 11 and a solid state disk (SSD) 15. A central processing unit (CPU) 12 and a dynamic random access memory (DRAM) 13 are disposed inside the host 11. The CPU 12 and the DRAM 13 can be used for accessing a command of a logical address of user data. The CPU 12 can transmit the command to the SSD 15 through a transmission interface 14. A controller 16 and a buffer memory 17 are disposed inside the SSD 15. The command of the logical address of the user data transmitted from the host 11 can be received by the controller 16. The controller 16 detects a physical address of a flash memory 19 in the flash memory array 18 according to information of the logical address. The user data can be saved in the buffer memory 17. Then, the user data can be saved in the DRAM 13 of the host 11 for backing up the user data in the host 11.

Additionally, the SSD 15 can perform a garbage collection mechanism regularly. The user data saved in some valid data pages inside a data segment of the flash memory 19 can be read out and then saved in the buffer memory 17. Then, the user data can be saved to another data segment. Then, the data segment is processed by using a data erasure mechanism for generating a blank data segment. The blank data segment can be reserved for saving another user data. In the present invention, the user data processed by the garbage collection mechanism and the user data accessed by using the host 11 can be written to different data segments for improving performance of the SSD 15.

To manage a correlation between a logical address and a physical address of the flash memory array 18, when the SSD 15 is powered up, the SSD 15 can read the managing data from the data segment of each flash memory 19 of the flash memory array 18. Accordingly, the logical address to physical address mapping table 20 (shown in FIG. 2) can be generated and then saved in the buffer memory 17. Further, the mapping table 20 is periodically backed up to the flash memory array 18 for avoiding information loss once the buffer memory 17 (i.e., volatile memory) is powered off.

Since the computational capability of the controller 16 of the SSD 15 is limited by its hardware, the number of processing data during a time interval is also limited. In FIG. 2, when the mapping table 20 is backed up from the buffer memory 17 to the flash memory array 18, the controller 16 executes two processes at the same time. The first process is to deal with the user data 21 in the buffer memory 17. The second process is to back up the mapping table 20 (i.e., say, the backup mapping table 22 is written from the buffer memory 17 to the flash memory 18). Although operation efficiencies for accessing the user data 21 and the backup mapping table 22 are decreased, the operation efficiency of the user data 21 is slightly decreased since the amount of backup mapping table data is relatively small. By doing so, the operation efficiency for accessing the user data 21 is satisfactory.

When the backup mapping table 22 is saved to the flash memory array 18 during a backup period T, user data 21a may be written to the flash memory array 18. Thus, the mapping table 20 of the buffer memory 17 may be dynamically amended. In other words, the mapping table 20 is different from the backup mapping table 22 since the user data 21a is introduced. The backup mapping table 22 currently transmitted cannot be updated according to the amendments. To ensure correctness of the backup mapping table 22, differences between the “amended” mapping table 20 by accessing the user data 21a and the backup mapping table 22 are also saved in the buffer memory 17. Here, the differences can be a recording log file of the differences (hereafter say, differences 23). Further, after the backup mapping table 22 is completely written to the flash memory array 18, the backup differences 24 are written to the flash memory array 18. When the power is turned off, the buffer memory 17 inherently erases all user data. When the power is turned on again, the SSD 15 can read the backup mapping table 22 and the backup differences 24 from the flash memory array 18 to the buffer memory 17. Then, the SSD 15 can use the backup differences 24 to update the backup mapping table 22 for rebuilding (or say, generating) the mapping table 20 rapidly in the buffer memory 17.

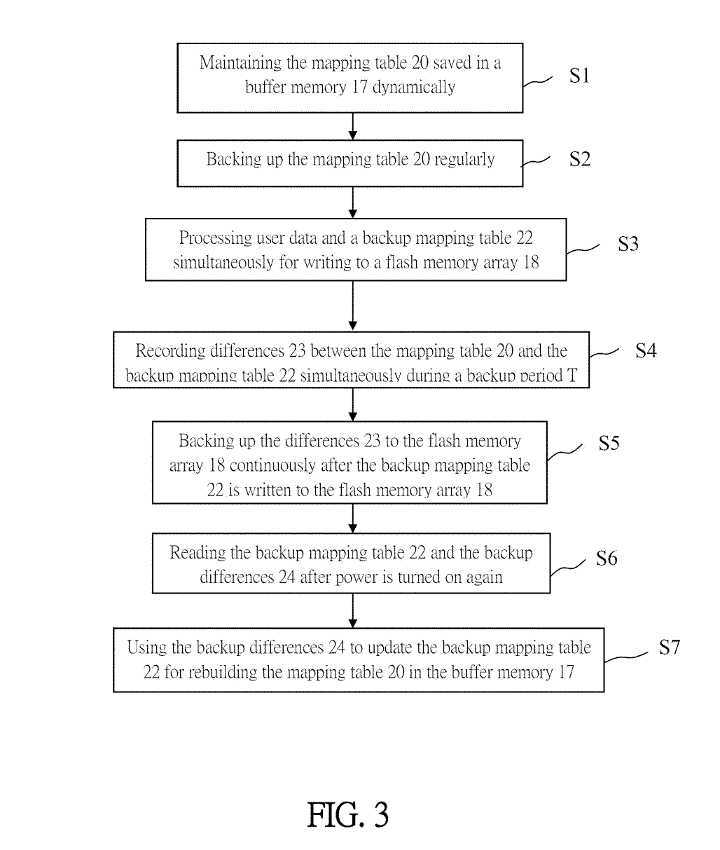

FIG. 3 is a flow chart of a method for rebuilding the mapping table 20 of the SSD 15. The method for rebuilding the mapping table 20 includes step S1 to step S7, as illustrated below.
step S1: maintaining the mapping table 20 saved in a buffer memory 17 dynamically;
step S2: backing up the mapping table 20 regularly;
step S3: processing user data and a backup mapping table 22 simultaneously for writing to a flash memory array 18;
step S4: recording differences 23 between the mapping table 20 and the backup mapping table 22 simultaneously during a backup period T;
step S5: backing up the differences 23 to the flash memory array 18 continuously after the backup mapping table 22 is written to the flash memory array 18;
step S6: reading the backup mapping table 22 and the backup differences 24 after power is turned on again;
step S7: using the backup differences 24 to update the backup mapping table 22 for rebuilding the mapping table 20 in the buffer memory 17.

Thus, in the method for rebuilding the mapping table 20 of the SSD 15, when the backup mapping table 22 is written to the flash memory array 18, the differences 23 with respect to accessing another user data are also recorded at the same time. The differences 23 become the backup differences 24 following the backup mapping table 22 and are written to the flash memory array 18. When the power is turned on again, the SSD 15 can use the backup differences 24 to update the backup mapping table 22 for rebuilding the mapping table 20 rapidly. Since the mapping table 20 can be rebuilt rapidly, the operation efficiency of the SSD 15 is satisfactory without introducing additional hardware.

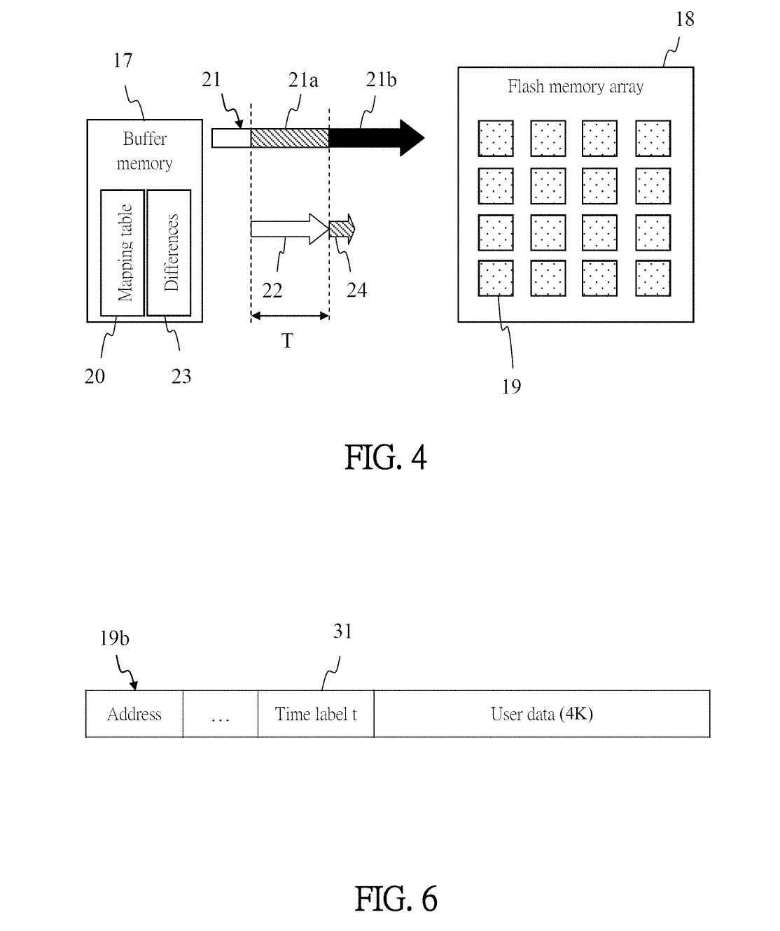

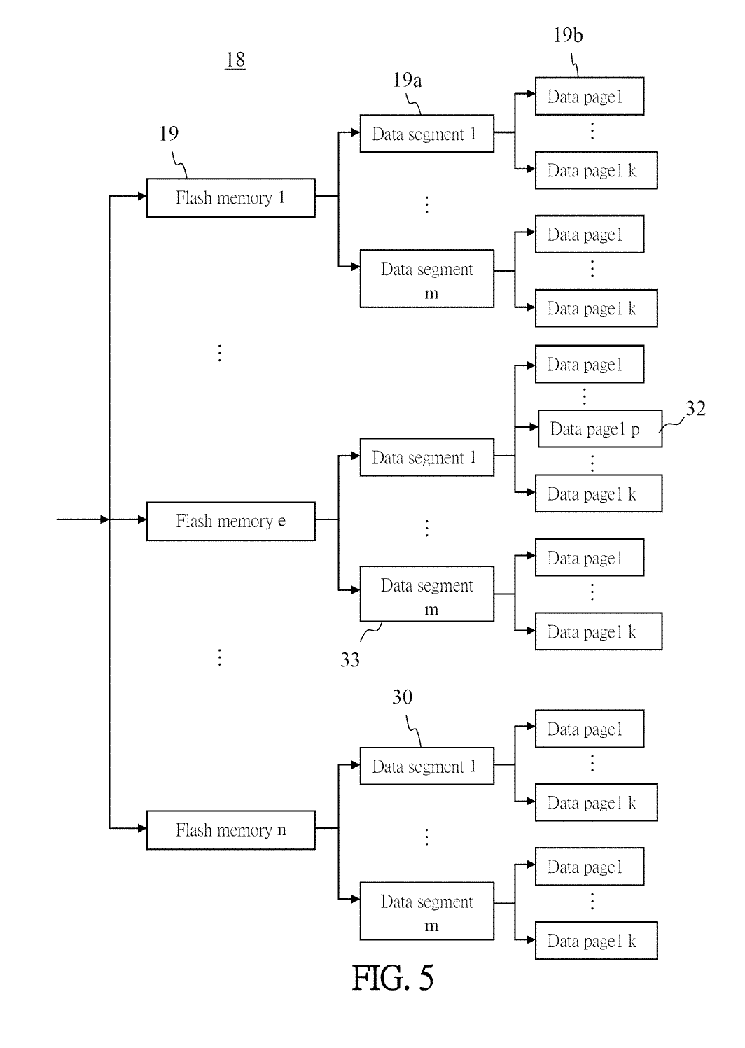

Please refer to FIG. 4 to FIG. 6. FIG. 4 is an illustration of another method for backing up the mapping table 20 of the SSD 15. FIG. 5 is a structure of the flash memory array 18 of the SSD 15. FIG. 6 is a structure of a data page of the SSD 15. The embodiment in FIG. 4 is similar to the embodiment in FIG. 2. In the embodiment in FIG. 2, when the power is turned off, no user data is prepared to be saved in the buffer memory 17. In the embodiment in FIG. 4, when the power is turned off, at least one piece of user data is prepared to be saved in the buffer memory 17. Note that the same elements follow the previous labels for simplicity. In FIG. 4, in the method for backing up the mapping table 20 of the SSD 15, the backup mapping table 22 is written to the flash memory array 18. At the same time, user data 21a may be written to the flash memory array 18 during the backup period T. The differences between the “amended” mapping table 20 by introducing the user data 21a and the backup mapping table 22 are also saved in the buffer memory 17. After the backup mapping table 22 is completely written to the flash memory array 18, backup differences 24 are written from the buffer memory 17 to the flash memory array 18. When the power is prepared to be turned off and at least one piece of user data is prepared to be saved in the buffer memory 17, the SSD 15 can control the at least one piece of user data to be directly saved in the flash memory array 18. For example, user data 21b is directly saved in the flash memory array 18. Thus, since the user data 21b is directly saved in the flash memory array 18, the backup differences 24 cannot record a change of the user data 21b. In other words, when the user data 21b is directly written to the flash memory array 18, since the backup differences 24 and the backup mapping table 22 cannot be updated, an error may be made in the backup mapping table 22.

In FIG. 5, to avoid the error of the backup mapping table 22, the flash memory array 18 includes n flash memories 19. Each flash memory 19 includes m data segments 19a. Here, n and m are two positive integers. Each data segment 19a includes 256 data pages 19b. In the embodiment, the user data 21, the backup mapping table 22, and the backup differences 24 are written to the flash memory array 18 at the same time. Generally, the backup mapping table 22 and the backup differences 24 are written to a designate data segment 30. In FIG. 6, in a data frame of each data page 19b, one field can be regarded as a time label field 31. The time label field 31 can record a time point (or say, time label) t of the backup mapping table 22 being saved. When the SSD 15 is powered up again, the SSD 15 can read a data page with a latest time point t recorded in the time label field 31 from the designate data segment 30. Then, the mapping table 20 can be rebuilt in the buffer memory 17 according to the backup mapping table 22 and the backup differences 24 saved in the data page with the time point t of the designate data segment 30.

Since each flash memory 19 has a limited erasure lifetime, when the user data has a big size, the SSD 15 can perform a dispersive data storage process for avoiding erasure lifetime reduction of the flash memory 19. Further, when the backup period T elapses, the backup differences 24 are written to the flash memory array 19. The SSD records the data page 19b with the user data 21b of the data segment 19a of the flash memory 19 as a flag data page 32. Then, the SSD 15 records a blank data segment 33 prepared to be used.

In the flash memory 19, to avoid program voltage interferences between two adjacent data pages 19b, an interval-based voltage programming method can be introduced. Thus, the flash memory 19 includes a default sequence for programming the data pages 19b. When the SSD 15 is powered on, a flag data page 32 is read out. Then, data pages 19b from the blank data segment 33 with recorded data following the recorded flag data page 32 are further read out. When the data pages 19b with time labels increased from the time point t of the time label of the flag data page 32 are found, the mapping table 20 in the buffer memory 17 can be updated according to the data pages 19b. By doing so, the mapping table 20 can be rebuilt or updated without scanning all data segments of the SSD 15.

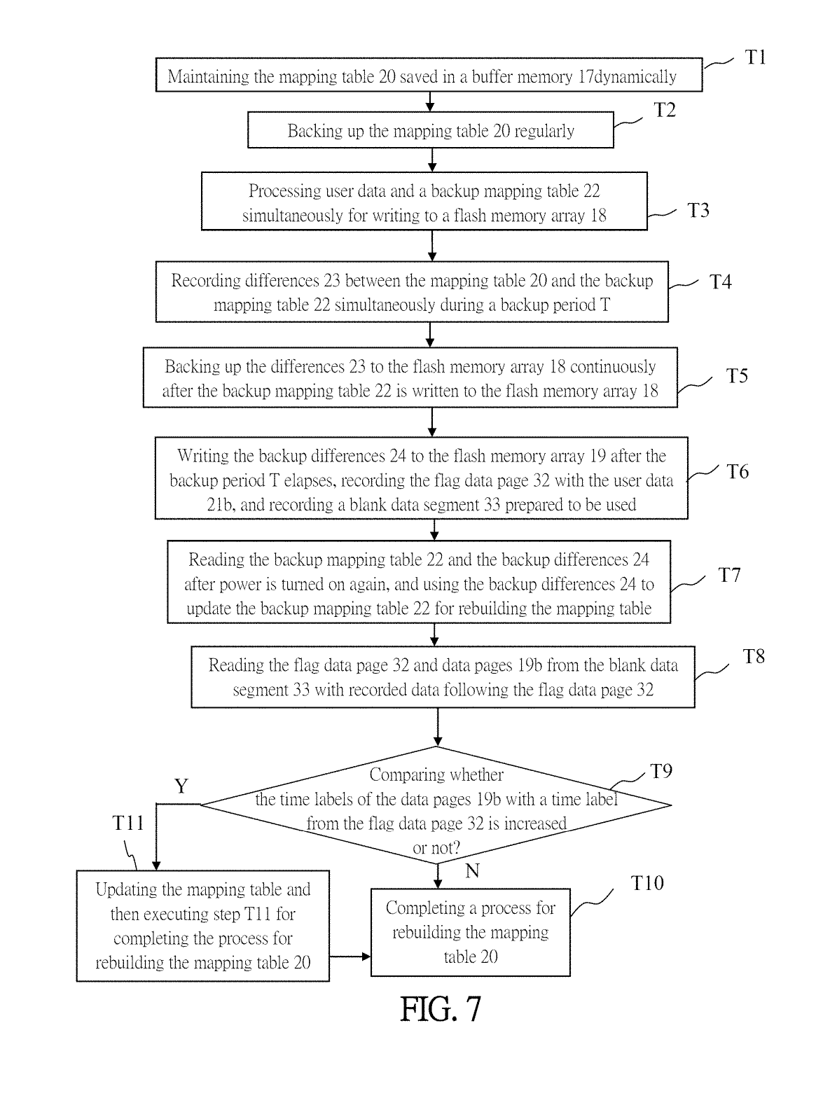

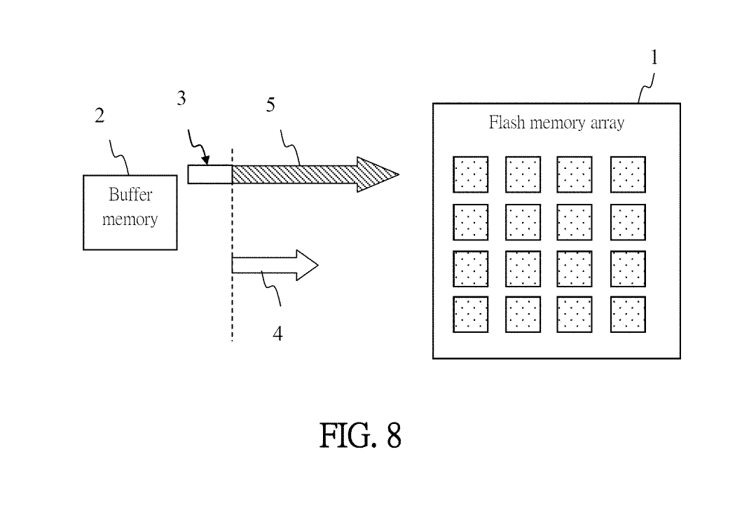

FIG. 7 is a flow chart of another method for rebuilding the mapping table 20 of the SSD 15. The method for rebuilding the mapping table 20 includes step T1 to step T11, as illustrated below.
step T1: maintaining the mapping table 20 saved in a buffer memory 17 dynamically;
step T2: backing up the mapping table 20 regularly;
step T3: processing user data and a backup mapping table 22 simultaneously for writing to a flash memory array 18;
step T4: recording differences 23 between the mapping table 20 and the backup mapping table 22 simultaneously during a backup period T;
step T5: backing up the differences 23 to the flash memory array 18 continuously after the backup mapping table 22 is written to the flash memory array 18;
step T6: writing the backup differences 24 to the flash memory array 19 after the backup period T elapses, recording the flag data page 32 with the user data 21b, and recording a blank data segment 33 prepared to be used;
step T7: reading the backup mapping table 22 and the backup differences 24 after power is turned on again, and using the backup differences 24 to update the backup mapping table 22 for rebuilding the mapping table 20;
step T8: reading the flag data page 32 and data pages 19b from the blank data segment 33 with recorded data following the flag data page 32;
step T9: comparing time labels of the data pages 19b with a time label of the flag data page 32; if the time labels of the data pages 19b are not increased from the time label of the flag data page 32, executing step T10; if the time labels of the data pages 19b are increased from the time label of the flag data page 32, executing step T11;
step T10: completing a process for rebuilding the mapping table 20.
step T11: updating the mapping table and then executing step T11 for completing the process for rebuilding the mapping table 20.

To sum up, a method for rebuilding the mapping table of the SSD is disclosed. When a backup period elapses, a data page can be recorded as a flag data page having user data at the same time. Blank data segments following the flag data page are also recorded. When the power is turned on again, the SSD can read the flag data page and data pages with recoded data from the blank data segments following the flag data page. Based on a time point labeled on the flag data page, the data pages with recent time labels can be found. Then, the mapping table can be updated accordingly. Thus, a processing time for rebuilding or updating the mapping table can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for rebuilding a mapping table of a solid state disk comprising:
maintaining the mapping table saved in a buffer memory dynamically;
backing up the mapping table regularly;
processing user data and a backup mapping table simultaneously for writing to a flash memory array;
recording differences between the mapping table and the backup mapping table simultaneously during a backup period;
backing up the differences to the flash memory array continuously after the backup mapping table is written to the flash memory array;
reading the backup mapping table and backup differences after power is turned on; and
using the backup differences to update the backup mapping table for rebuilding the mapping table in the buffer memory.

2. The method of claim 1, wherein a recording log file of the differences between the mapping table and the backup mapping table is saved in the buffer memory.

3. The method of claim 1, wherein when the backup period elapses, writing the backup differences to the flash memory array, and recording a data page as a flag data page having user data at the same time.

4. The method of claim 3, wherein when the backup period elapses, recording a blank data segment value prepared to be used.

5. The method of claim 4, wherein after the mapping table is generated, reading a recorded flag data page and a data page with recorded data following the recorded flag data page.

6. The method of claim 5, wherein the data page with the recorded data following the recorded flag data page having a default programming sequence.

7. The method of claim 5, wherein after the mapping table is generated, reading a data page with recorded data from the blank data segment prepared to be used.

8. The method of claim 7, wherein when time labels of data pages already read are non-increased from a time label of the flag data page, completing a process for rebuilding the mapping table.

9. The method of claim 7, wherein when time labels of the data pages already read are increased from a time label of the flag data page, updating the mapping table according to the data pages already read, and then completing a process for rebuilding the mapping table.
